(19) United States
(12) Patent Application Publication
(10) Pub. No.: US 2003/0165593 A1
(43) Pub. Date: Sep. 4, 2003

(54) Process

(76) Inventors: Lisbeth Hoj Johansen, Odder (DK); Susanne Lorenzen, Aarhus C (DK)

Correspondence Address: FROMMER LAWRENCE & HAUG, 745 FIFTH AVENUE- 10TH FL., NEW YORK, NY, 10151, US

(21) Appl. No.: 10/162,751

(22) Filed: Jun. 5, 2002

(30) Foreign Application Priority Data
Jun. 7, 2001 (GB) 0113922.9

(51) Int. Cl. A23L 1/10

(52) U.S. Cl. 426/18

(57) ABSTRACT

There is provided a process for the preparation of a modified masa foodstuff, the process comprising the steps of (i) preparing a masa by nixtamalisation of corn (ii) contacting an enzyme with (a) the masa, and/or (b) the corn prior to nixtamalisation; such that starch native to the corn is modified.

### RELATED APPLICATIONS

This application claims priority from UK application 0113922.9, filed Jun. 7, 2001. Each of the foregoing applications and patents, and each document cited or referenced in each of the foregoing applications and patents, including during the prosecution of each of the foregoing applications and patents (“application cited documents”) and any manufacturer's instructions or catalogues for any products cited or mentioned in each of the foregoing applications and patents and in any of the application cited documents, are hereby incorporated herein by reference. Furthermore, all documents cited in this text, and all documents cited or referenced in documents cited in this text, and any manufacturer's instructions or catalogues for any products cited or mentioned in this text, are hereby incorporated herein by reference.

### FIELD OF THE INVENTION

The present invention relates to a masa foodstuff. In particular, the present invention relates to a masa foodstuff comprising a modified starch wherein the unmodified starch is native to corn.

Corn provides the base ingredient for many staple foodstuffs. For example, corn may be processed to produce masa. Masa is the raw material for production of products such as corn tortilla, soft tortilla, corn chips, tortilla chips, taco shells, tamales. Masa is produced by a nixtamalisation process (also called alkaline cooking process). The nixtamalisation process involves cooking corn which still carries its outer shell (the pericarp). The cooking is performed in an alkaline solution such as lime (calcium hydroxide) and generally is for 12 to 24 hours. The cooked product is then steeped and washed to produce nixtamal. The nixtamal is then stone-ground to a soft moist dough called masa.

For the convenience of a domestic user or for some commercial users, it is desirable to provide the dry flour, or instant tortilla flour, that is called masa harina. Certain known processes for making masa harina include U.S. Pat. No. 826,983 disclosing steeping corn in the traditional manner, followed by drying the kernels and grinding into flour. U.S. Pat. No. 987,560 teach a process for partially boiling corn in calcium hydroxide solution and then grinding the wet kernels into paste. Water is pressed from the paste, followed by drying of press cake in a heated chamber, followed in turn by grinding into flour. A similar process is disclosed in U.S. Pat. No. 1,262,144 where the amount of lime in water is one-half per cent, and in U.S. Pat. No. 1,334,366 calls for molding of dough into small thin cakes which are dried and then ground into flour. A similar process is described in U.S. Pat. No. 2,584,893.

U.S. Pat. No. 2,704,257, U.S. Pat. No. 2,854,339 and U.S. Pat. No. 2,930,699 disclose steeping of corn in calcium hydroxide solution at a temperature well below the gelatinisation point of starch of the corn, followed by drying of the whole steeped corn in a hot airstream while simultaneously comminuting it to obtain a flour which has been dried at temperatures less than 74° C. to a moisture content of not more than 10% by weight. The patents also describe apparatus for use in the drying and grinding steps.

U.S. Pat. No. 4,463,022 discloses a method for producing masa comprising the steps of placing the dry corn kernels in a vessel of boiling water and maintaining the water boiling for about five minutes. Heat is removed from the vessel, and the water and corn kernels are allowed to cool for about two hours under ambient conditions, bringing the temperature down to about 160° F. The corn kernels are then further cooled and washed by establishing a low volume flow of cool tap water through the vessel for about an additional two hours. Following this treatment, the hulls of the kernels are broken by passing the kernels through a set of crushing rolls spaced apart about one-eighth of an inch. Thereafter, the mass of hull-broken kernels is entirely, hull and all, forced through a plate perforated as a sieve, the perforations being very small in relation to the size of the corn kernels. This produces a uniform and highly desirable masa product. The moisture content of the mass of material is desirably adjusted to about 50% by weight, either before or after the material is forced through the perforations.

After production masa may then be treated in a number of ways. The masa may be introduced into, for example, a tortilla mold or a tortilla sheeter. This is the traditional end use for the masa. In an alternative, the masa can be dried and milled into a “shelf-stable” flour product. The masa may be reconstituted from the flour product at a later stage and then formed into a food product, such as tortilla.

With regard to industrial implementation, typically masa is sold in the form of the dried masa or is formed into a final food product, such as a tortilla, which is then packed. In both of these aspects, one of the advantages of providing the product in this form is that the end user is free of the need to prepare the nixtamal and masa from the corn constituent. The requirements for labour, energy and processing time for the end use are reduced. Moreover, the product is simple to use.

Limitations in supply chains, particularly in developing regions which predominantly consume masa based products, require that corn products, such as tortillas, should typically retain their properties for at least 7 days after production.

Additives to corn tortillas and their effects on storage stability are discussed in the prior art. For example, J. C. Yau et al., “Effects of Food Additives on Storage Stability of Corn Tortillas”, Cereal Foods World, May 1994, Volume 39, No. 5, 397-402 discusses the incorporation of vegetable and animal proteins, gums, emulsifiers, modified starches and polyols into nixamalised corn flour during processing. The rheological properties (rollability and pliability), machinability, moisture content, and organoleptic properties were evaluated. The properties of the tortilla were measured when the tortilla was cold. Since starch retrogrades under storage, it may be concluded that Yau et al. are concerned with the effects of starch in the tortilla. Yau et al. discuss that at least some of the disclosed additives may provide a gel network which improves the retention of steam and the extent of puffing of corn tortillas on cooking. Moreover, it is discussed that proteins in corn masa do not form a gel network.

Further prior art disclosures of additives to corn masa products are provided by WO 96/39864, WO 95/14397, and U.S. Pat. No. 3,655,385. WO 96/39864 relates to the production of “fat free” corn chips made from corn flour or masa. The chips contain (i) up to 50% masa, (ii) starch, protein or fibre and (iii) a filler. Component (ii) and (iii) are incorporated to reduce the fat content of the corn chips.

WO 95/14397 relates to extruding a cereal grain dough containing a gum such as carboxymethylcellulose (CMC) and an optional protein to provide a product for subsequent frying. The fried food product may be a corn chip. This document teaches that gums are incorporated to allow correct hydration of the starch component of the corn flour. WO 95/14397 relates to the extrusion of a cereal grain—an alkaline treatment step (nixtamalisation) of the grain is explicitly avoided.

U.S. Pat. No. 3,655,385 relates to the prevention of staling in tortillas containing a hydrophilic edible gum. Prevention of staling is said to be achieved by the water retention of the hydrophilic gum.

WO 00/45647 to the present applicant teaches that a masa foodstuff may be prepared by contacting a reducing agent or an enzyme with masa, and/or corn prior to nixtamalisation. Protein native to the corn is modified. This provides improved handling properties.

According to a first aspect of the present invention there is provided a process for the preparation of a modified masa foodstuff, the process comprising the steps of (i) preparing a masa by nixtamalisation of corn (ii) contacting an enzyme with (a) the masa, and/or (b) the corn prior to nixtamalisation; such that a starch native to the corn is modified.

According to a second aspect of the present invention there is provided a process for the preparation of a modified masa foodstuff, the process comprising the steps of (i) preparing a masa by nixtamalisation of corn (ii) contacting a reducing agent or an enzyme with (a) the masa, and/or (b) the corn prior to nixtamalisation; such that a protein and/or starch native to the corn is modified; (iii) contacting an oxidising agent with the modified protein and/or starch.

According to a third aspect of the present invention there is provided a masa foodstuff obtainable or obtained by a process as defined in any one of the preceding claims.

According to a fourth aspect of the present invention there is provided use of an enzyme to improve the interaction of starch in a masa foodstuff, wherein the starch is native to the corn.

According to a fifth aspect of the present invention there is provided use of a reducing agent or an enzyme in combination with an oxidising agent to improve the interaction of a protein in a masa foodstuff, wherein the protein is native to the corn.

According to a sixth aspect of the present invention there is provided a foodstuff comprising (i) corn; (ii) a modified starch and/or modified protein wherein the unmodified starch and/or unmodified protein is native to the corn; (iii) amylase; (iv) ascorbic acid; and (v) a reducing agent.

We have identified that by use of an enzyme, such as amylase, one may modify starch in a masa foodstuff. The modification may provide an improved shelf life by, for example prevention of starch retrogradation. This may also improve the rollability, foldability and flexibility of the tortillas. It is also believed, that by degradation of the starch, improved interactions between the starch and the proteins will occur. A creation of a better network will increase the resistance (strength) of the tortillas.

By the term “nixtamalisation” it is meant heating corn which still carries its outer shell (the pericarp) in an alkaline solution. Preferably the alkaline solution is an aqueous solution of lime or calcium hydroxide.

The present invention may provide a masa foodstuff having improved handling properties. For example when the masa foodstuff is a tortilla the present invention improves rollability of the tortilla. Yet further when the masa foodstuff is a tortilla the present invention improves foldability of the tortilla.

In the present specification the term “corn” is analogous to the US terminology “maize”. In the present specification by the term “corn” it is meant the seed or kernel of a corn or maize plant.

In the present specification by the term “modified protein” it is meant a protein which has been modified from its native state by a reducing agent, an enzyme and/or oxidising agent.

In the present specification by the term “modified starch” it is meant starch which has been modified from its native state by an enzyme.

In the present specification by the term “native to corn” it is meant a protein or starch which is present in complete corn.

### PREFERRED ASPECTS

Preferably the starch modifying enzyme utilised to modify the starch is amylase,

In a preferred aspect the starch modifying enzyme contacted material in which starch has been modified is also contacted with a reducing agent or an enzyme; such that a protein native to the corn is modified. In a highly preferred aspect the protein modified material is also contacting an oxidising agent.

Thus in a preferred aspect the process of the first aspect of the present invention comprises the steps of (iii) contacting a reducing agent or an enzyme with (a) the masa, and/or (b) the corn prior to nixtamalisation; such that a protein native to the corn is modified; (iv) contacting an oxidising agent with the modified protein.

The protein may be modified with an enzyme or a reducing agent. Both modification agents have advantages. The advantages of the protein modifying enzymes apply also to starch modifying enzymes. By the term “modified” in respect of the protein native to corn it is preferably meant that the conformation of the protein is changed. In one aspect by the term “modified” it is preferably meant that a peptide or disulphite bond of the protein is cleaved.

Enzymes may be contacted with the corn product, such as the nixtamal, the masa or the masa flour. The enzymes modifies the starch and/or protein native to the corn. The activity of the enzyme may then be readily terminated by heating the enzyme. Heating will denature the enzyme and therefore the activity thereof will cease.

The use of an enzyme is particularly advantageous because denatured enzyme need not be disclosed in a food ingredient listing after denaturation. Food labeling regulations consider enzymes to be processing aids. Denatured enzymes need only be declared as protein.

The activity of reducing agents is easier to control than that of enzymes. However, the reducing agent must be separated from the corn containing food material after contact therewith or, if it remains in the foodstuff, it must be declared in an ingredients list.

Typical starch modifying enzymes may be selected from amylases such as amylases of plant origin (such as GRINDAMYL^{RTM}) or fungal or bacterial amylases (such as GRENDAMYL^{RTM}).

Typical protein modifying enzymes may be selected from reductases, oxidising enzymes (including glucose oxidase, hexoseoxidase, transglutaminase), proteases such as disulfide isomerase and other enzymes that act on disulfide bonds, bacterial proteases such as GRINDAMYL™ PR 41, and GRINDAMYL™ PR 43, fungal proteases such as GRINDAMYL™ PR 59 (a proteolytic enzyme complex produced from Aspergillus oryzae), and mixtures thereof, including mixtures of bacterial and fungal proteases such as GRINDAMYL™ PR 46. Each of GRINDAMYL™ PR 41, GRINDAMYL™ PR 46, GRIDAMYL™ PR 43, and GRINDAMYL™ PR 59, are available from Danisco, Denmark

Preferably, the protein modifying enzyme is a protease. A proteases may be selected such that a suitable degree of modification of a native corn protein is provided.

Typical reducing agents may be selected from L-cystein, metabisulfite, inactivated yeast extract (glutathione), derivatives and mixtures thereof.

Typically the masa or the corn may be contacted with the starch modifying enzyme, protein modifying enzyme and/or reducing agent for 5 to 20 minutes, or in one aspect 10 to 20 minutes. This period of contact is usually sufficient to modify the starch and/or proteins native to the corn to a sufficient degree such that the required improved interaction occurs.

The contact with an oxidising agent is generally applicable to systems in which a native corn protein is modified. Thus, as described above, according to a second aspect of the present invention there is provided a process for the preparation of a modified masa foodstuff, the process comprising the steps of (i) preparing a masa by nixtamalisation of corn (ii) contacting a reducing agent or an enzyme with (a) the masa, and/or (b) the corn prior to nixtamalisation; such that a protein and/or starch native to the corn is modified; (iii) contacting an oxidising agent with the modified protein and/or starch. In this aspect preferably

the enzyme is selected from protease, reductase, glucose oxidase, hexoseoxidase, transglutaminase and mixtures thereof

the reducing agent is selected from L-cystein, metabisulfite, inactivated yeast extract (glutathione), derivatives and mixtures thereof.

Preferably the oxidising agent is ascorbic acid.

Preferably, the masa foodstuff of the present invention is selected from corn tortilla, soft tortilla, corn chips, tortilla chips, taco shells, tamales, derivatives and mixtures thereof. More preferably the foodstuff is a tortilla.

In a preferred aspect the masa foodstuff further comprises a hydrocolloid.

Preferably, the hydrocolloid is selected from carboxymethylcellulose (CMC), carrageenan, guar gum, pectin and mixtures thereof. In a highly preferred aspect the hydrocolloid is at least a mixture of CMC and carrageenan. Preferably the hydrocolloid is carrageenan.

In a preferred aspect the masa foodstuff further comprises carrageenan.

In a preferred aspect the masa foodstuff further comprises guar.

In a preferred aspect the masa foodstuff further comprises carrageenan and guar.

As disclosed above in one aspect the present invention provides a foodstuff comprising (i) corn; (ii) a modified starch and/or modified protein wherein the unmodified starch and/or unmodified protein is native to the corn; (iii) amylase; (iv) ascorbic acid; and (v) a reducing agent.

In a preferred aspect the foodstuff further comprises a hydrocolloid, preferably carrageenan and/or guar gum.

In a preferred aspect the reducing agent is sodium metabisulphite.

In aspects of the invention the (masa) foodstuff of the present invention or prepared in accordance with the present invention comprises glucose.

In a highly preferred aspect the present invention provides a (masa) food stuff comprising

| | |
|---|---|
| Guar gum in an amount of | 60-90% |
| Glucose | 10-15% |
| Carrageenan | 1-2% |
| Amylase | 1.2-1.7% |
| Ascorbic acid | 1-1.5% |
| SMS (Sodium metabisulphite) | 0.2-0.3% |

The present invention provides improvements not only to the process for preparation of a modified masa foodstuff, but also to the masa produced in the course of the process and to the final product which is a modified masa product such as a corn tortilla or a soft tortilla. The production time may typically be reduced by use of the present invention because improvements in the quality of the masa result in fewer problems during production. Furthermore, the production may be more stable since use of the present invention results in a more consistent quality of masa. The masa itself typically has reduced stickiness and better cohesiveness which results in improved machinability. Furthermore, by use of the present invention, more water may typically be added to the masa, which provides the advantage of increased production yield. The modified masa foodstuff has many advantages over the conventional masa foodstuffs of the prior art. For example, where the modified masa foodstuff is a tortilla, the tortilla will typically: have improved flexibility and elasticity; be softer, especially at the edges; have increased resistance; have a smoother surface; undergo less shrinkage during heating and taste better.

The present invention provides the additional advantage that by use of the present invention, certain conventional ingredients in masa foodstuff may be added in reduced quantities or may be omitted altogether. In particular, it has been found that the quantity of CMC may be reduced without any negative effect on the quality of the modified masa foodstuff. It has further been found that Etil Maltol may be omitted without any reduction in organoleptic properties of the modified masa foodstuff.

The present invention is further advantageous because it allows for the use of strong corn or flour from hard milling corn originating from North America, in particular the US. US flour contains protein which has weak interactions due to their compact structure. Thus the present invention allows for the use of this corn in preparing masa foodstuffs in which the handling properties of the product would normally prohibit the use of US flour.

In summary, the present invention provides a masa foodstuff in which the interaction of native starch is improved such that handling and/or texture of the masa foodstuff is improved.

Preferably, the viscosity of an aqueous suspension of the masa foodstuff of the present invention, more preferably a tortilla corn product, is from 6 to 20 cP, more preferably from 13 to 15 cP.

The present invention will now be described in further detail by way of example only with reference to the accompanying figures in which:-

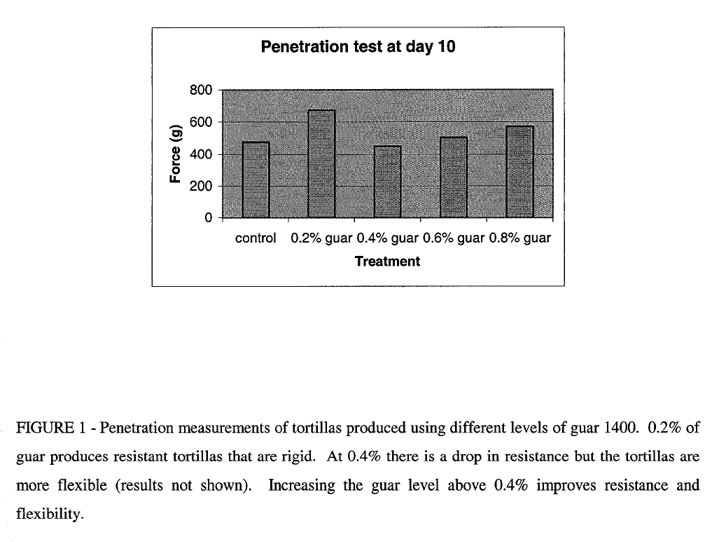

FIG. 1 shows penetration measurements of tortillas produced using different levels of guar 1400. 0.2% of guar produces resistant tortillas that are rigid. At 0.4% there is a drop in resistance but the tortillas are more flexible (results not shown). Increasing the guar level above 0.4% improves resistance and flexibility;

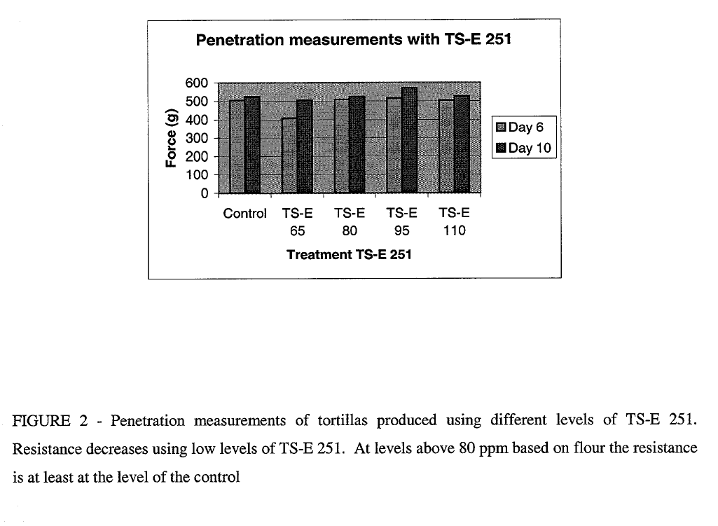

FIG. 2 shows penetration measurements of tortillas produced using different levels of TS-E 251. Resistance decreases using low levels of TS-E 251; and

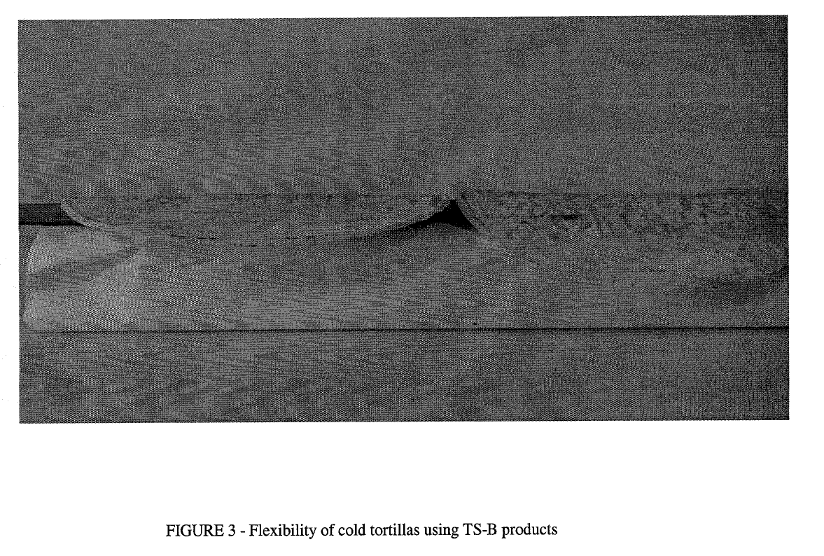

FIG. 3 demonstrates the flexibility of cold tortillas using TS-B products and illustrates, that with the use of combined ingredients a softer and more flexible tortilla can be obtained. The figure shows 1 month old cold tortilla, where the control is rigid and stiff. This tortilla is not able to bend around the stick, and the rollability for the tortilla is poor. The TS-B tortilla is still soft and flexible and has an improved rollability compared to the control.

The present invention will now be described in further detail in the following examples.

### EXAMPLES

The material and methods used in the examples are described below.

Materials and methods:

Pilot scale testing

2000 g corn flour

0.5% salt

0.5% calcium propionate *

0.3% g fumaric acid *

approx. 132-136% water (BU should be 270-300 at 35° C.)

* The use of preservatives varies depending on pH in the dough (masa). pH should be 5.0-5.5.

Kneading and dough handling conditions:

Kneading is conducted at ambient temperature in a Bjørn mixer at lowest speed. Dry mixing for 5 min. followed by 1 min. after addition of water. Dough temperature should be 35° C.

After mixing the masa rests for 10 minutes at 35° C., 85%RH.

The masa is subjectively evaluated for stickiness, and comments are given.

Baking:

Tortillas are baked in a tortilla gas oven model CFO-40 with the following temperature settings:

| | |
|---|---|
| Top: | 290-320° C. |
| Middle: | 270-300° C. |
| Bottom: | 180-200° C. |

After baking the tortillas are placed on baking grids and placed into a humidity chamber at 25° C. and 80%RH.

Cooling:

Following the cooling the tortillas are packed into labelled plastic bags (10 tortillas/bag).

The tortillas are kept at ambient temperature in between the evaluations.

Analysis:

Farinograph:

After mixing 75 g dough is used for Farinograph measurements.

The measurements are conducted at 63 rpm at 35° C.

The resistance (BU) is recorded after 4 min.

Dough liquor viscosity:

2×6 g of dough are after mixing weighed and added to the 50 ml centrifuge tubes along with 10 ml of distilled water. The dough/water is homogenised using an Ultra Turrex for 20 sec. at 8000 rpm followed by 40 sec. at 20500 rpm. The suspension is centrifuged at 10000 rpm (10800 g value) for 4 min. 0.5 ml of the supernatant is used for viscosity determination in a Brookfield viscometer. The measurements are conducted at 11° C. at 5-10 rpm.

The viscosity should be in the area 6-20 cP, depending on the additives in the actual flour.

For protein determination OD (optical density) is measured at 280 nm after 30 and 60 times dilution of the supernatant.

Rheological analysis using a Texture Analyser TA.XT2:

Dough stickiness:

A modified stickiness test is used. The measurements are conducted essentially as described by Hoseney and Chen 1992 (“Dough stickiness, causes and measurements” Weizhi Chen, Manhattan, Kansas 1992) except that the cells are kept in contact with the masa dough for 5 seconds. The results are given in grams. The positive force is the force required to penetrate the masa dough. The negative force is the force required to pull the cells apart from the masa dough.

Penetration test:

The method is conducted by placing the tortillas between 2 metal rings in order to hold the tortilla during the measurement. The tortilla is first heated using an electric hotplate at approx. 250° C. The tortilla is warmed for 15 seconds on each side following by 10 seconds on the first side.

The penetration test starts 2 min. after the initiating of the warming process.

Minimum 3 tortillas are used for penetration test to evaluate the strength of the tortillas.

The settings for the penetration test is the following:

| | | |
|---|---|---|
| Pre speed: | 1 | |
| Test speed: | 1 | |
| Post speed: | 10 | |
| Break: | 1 | |
| Distance: | 30 | mm |
| Force: | 40 | g |
| Time: | 0.1 | |
| Return to trigger | | |
| Compression | | |
| Return to start | | |
| 200 pps | | |
| Fracture TPA | | |

The test measures the force in grams needed to penetrate and break the tortilla. This correlates with the strength of the tortillas. The disadvantage is however that the method measure the strength in a given point, which is difficult to connect to the tortillas ability to roll around different kinds of fillings, which is the way to consumer will evaluate the strength of the tortillas. A high quality tortilla should be able to roll without breaking.

A rigid tortilla will have a high penetration force, but this will be difficult to roll without breaking. Even though the method also measures the distance for the rupture of the tortillas, this is difficult to correlate with the elasticity and extensibility of the tortillas.

The tortillas are preferable penetrated in the centre of the tortilla.

The surface of the tortilla has a high influence on the actual force measured. Puffings in the tortillas will for example provide a lower value for the needed force, glossy areas will also affect the measurements.

Strength and flexibility of the tortillas are also evaluated subjectively, as the use of the penetration test provides difficulties in giving a good correlation with the way the consumer will handle and evaluated the tortillas.

Evaluation of baked tortilla is conducted over a period of 1-14 days depending on the results obtained.

The following examples are used to illustrate that the development of a good protein network, which are able to give a tortilla with a good strength (resistance) and flexibility, can be obtained by selecting the right combination of different ingredients.

### Example 1

Testing of different single ingredients—guar gum, amylase (TS-E 251), ascorbic acid and SMS (sodium metabisulphite).

The control is used as reference. CMC H is a special type, which will give a high resistance of the tortillas, but due to this, it will loose flexibility.

TABLE 1
Results from analysis of masa

| | | Tortilla | Masa | | | |
|---|---|---|---|---|---|---|
| | Stickiness | weight | temp. | | Viscosity | Masa consistency |
| Ingredients | (g) | (g) | (° C.) | O.D. | (cP) | subjective evaluation |
| Control | 40 ± 2 | 30.6 | 33.5 | 0.485 | 4.0 | Wet |
| 0.5% | 46 ± 4 | 31.1 | 33.6 | 0.634 | 15 | Wet and sticky |
| CMC 1250 | | | | | | |
| 0.5% | 43 ± 3 | 29.6 | 33.3 | 0.497 | 11 | Wet and sticky |
| CMC H | | | | | | |
| 0.2% guar | 46 ± 2 | 30.1 | 33.4 | 0.501 | 6.8 | |
| 0.4% guar | 39 ± 3 | 31 | 33.3 | 0.499 | 9.5 | Masa begins to be |
| | | | | | | cohesive |
| 0.6% guar | 35 ± 2 | 31.1 | 33.4 | 0.535 | 15 | Cohesive masa mixer is |
| | | | | | | clean |
| 0.8% guar | 33 ± 3 | 31.2 | 33.6 | 0.493 | 22 | Cohesive, clean mixer |
| 50 ppm | 44 ± 3 | 30.2 | 32.8 | 0.514 | 4.1 | Soft masa a bit sticky. |
| TS-E 251 | | | | | | Mixing was not optimal |
| 65 ppm | 43 ± 1 | 31 | 33.3 | n.d | n.d | Do. |
| TS-E 251 | | | | | | |
| 80 ppm | 44 ± 1 | 32.9 | 33.9 | n.d | n.d | Do. |
| TS-E 251 | | | | | | |
| 95 ppm | 45 ± 2 | 32.1 | 33.9 | n.d | n.d | Do. |
| TS-E 251 | | | | | | |
| 110 ppm | 38 ± 2 | 31.7 | 34 | 0.533 | 4.3 | Do. |
| TS-E 251 | | | | | | |
| 50 ppm | 42 ± 3 | 33.1 | 34.4 | 0.540 | 4.4 | Wet |
| Asc. | | | | | | |
| 75 ppm | 39 ± 3 | 32.3 | 34.2 | n.d | n.d | Masa is elastic and wet |
| Asc. | | | | | | |
| 100 ppm | 42 ± 4 | 32.1 | 34.5 | n.d | n.d | Do. |
| Asc. | | | | | | |
| 125 ppm | 49 ± 3 | 32.1 | 34.5 | n.d | n.d | Do. |
| Asc. | | | | | | |
| 150 ppm | 47 ± 2 | 32.6 | 34.7 | 0.549 | 4.1 | Do. |
| Asc. | | | | | | |
| 50 ppm | 49 ± 2 | 32.4 | 33.5 | 0.508 | 4 | Soft masa and a bit sticky |
| SMS | | | | | | |
| 75 ppm | 54 ± 3 | 32.5 | 33.7 | n.d | n.d | Do. |
| SMS | | | | | | |
| 100 ppm | 52 ± 3 | 31 | 33.5 | 0.559 | 4.8 | Softer than 18, sticky |
| SMS | | | | | | |

n.d not detected

TABLE 2
Results from penetration measurements

| | Force day 6 | Force day 10 |
|---|---|---|
| Ingredients | (g) | (g) |
| Control | 551 ± 23 | 475 + 27 |
| 0.5% | 663 ± 83 | 692 + 51 |
| CMC 1250 | | |
| 0.5% CMC H | 705 ± 82 | 787 + 150 |
| 0.2% guar | 603 ± 24 | 677 + 64 |
| 0.4% guar | 566 ± 46 | 450 + |
| 0.6% guar | 543 ± 77 | 502 + 107 |
| 0.8% guar | 566 ± 24 | 571 + 24 |
| 50 ppm | 526 ± 54 | 564 + 100 |
| TS-E 251 | | |
| 65 ppm | 409 ± 8 | 504 + 37 |
| TS-E 251 | | |
| 80 ppm TS-E 251 | 508 ± 93 | 524 + 47 |
| 95 ppm | 516 ± 8 | 570 + 170 |
| TS-E 251 | | |
| 110 ppm TS-E 251 | 503 ± 9 | 527 + 7 |
| 50 ppm Asc. | 494 ± 92 | 631 + 40 |
| 75 ppm Asc. | 559 ± 83 | 537 + 94 |
| 100 ppm Asc. | 527 ± 96 | 630 + 22 |
| 125 ppm Asc. | 585 ± 52 | 488 + 45 |
| 150 ppm Asc. | 505 ± 39 | 581 + 20 |
| 50 ppm SMS | 567 ± 25 | 600 + 28 |
| 75 ppm SMS | 610 ± 36 | 512 + 139 |
| 100 ppm SMS | 600 ± 118 | 513 + 136 |

Increasing the level of guar 1400 to at least 0.6% (based on flour) improves all tortilla quality parameters such as: masa consistency, tortilla flexibility and resistance.

The resistance is highest using guar 1400 in levels of 0.2%. However the produced tortillas are rigid. Subjective evaluation of the tortilla flexibility demonstrated, that TS-E 251 must be added at a level of 90 ppm in order to obtain a positive effect on this quality parameter.

Penetration measurements of warm tortilla showed, that the resistance is at the level of the control, when using 80 ppm of TS-E 251. Increasing the level to 95 and 110 ppm seems to improve resistance compared to control.

The use of ascorbic acid improves elasticity of masa and tortilla when used in dosages from 75 ppm to 125 ppm (subjective evaluations). The penetration measurements showed no negative effect on tortilla resistance using these levels. There was a tendency, that resistance is improved using 50 ppm to 100 ppm of ascorbic acid.

The use of SMS in levels from 50 to 100 ppm improves rollability/flexibility of tortillas. Penetration measurements demonstrate, that SMS initially produce an increase in resistance but that a high level (above 75 ppm) induces a reduction in tortilla resistance over time (10 days).

### Example 2

Different combinations of relevant ingredients are tested.

| | | | | | Glucose |
|---|---|---|---|---|---|
| | TS-E 251 | SMS | Ascorbic acid | Guar gum | (dextrose) |
| | 95 ppm | 60 ppm | 125 ppm | 0.6% | 0.2% |
| Control | | | | X | |
| Comb. 1 | X | X | X | X | X |
| Comb. 2 | 110 ppm | X | X | X | X |
| Comb. 3 | X | 90 ppm | X | X | X |
| Comb. 4 | X | X | 90 ppm | X | X |
| Comb. 5 | X | X | | X | X |
| Comb. 6 | X | | X | X | X |
| Comb. 7 | | X | X | X | X |
| Comb. 8 | X | | | X | X |
| Comb. 9 | | X | | X | X |
| Comb. 10 | | | X | X | X |
| Comb. 11 | X | X | X | X | |
| Comb. 12 | X | X | X | | |

X = The dosage given in the “headings”

TABLE 3
Results from analysis of the masa

| | | | | Masa |
|---|---|---|---|---|
| | | | Masa | Consistency |
| | Stickiness | Tortilla weight | temp. | Subjective |
| | (g) | (g) | (° C.) | evaluation |
| Control | N.d. | 31.7 | 32.2 | |
| Control | 36 ± 4 | 33.1 | 33.4 | Big puffings, |
| guar | | | | |
| Comb. 1 | 40 ± 4 | 32.9 | 33.3 | Big puffings |
| Comb. 2 | 41 ± 2 | 32.5 | 33.4 | More sticky than 1 |
| Comb. 3 | 43 ± 3 | 33.2 | 32.6 | Big puffings |
| Comb. 4 | 48 ± 1 | 33.4 | 33.7 | |
| Comb. 5 | 36 ± 3 | 33.6 | 34.1 | Low stickiness |
| Comb. 6 | 32 ± 2 | 33.2 | 33.2 | |
| Comb. 7 | 32 ± 3 | 34.1 | 33.6 | |
| Comb. 8 | 32 ± 2 | 33.3 | 33.2 | |
| Comb. 9 | 30 ± 4 | 33.5 | 35.2 | |
| Comb. 10 | 31 ± 1 | 32.3 | 34 | |
| Comb. 11 | 37 ± 4 | 33.1 | 35.6 | |
| Comb. 12 | 43 ± 4 | 33.1 | 34.7 | Sticky masa |

TABLE 4
Results from penetration measurements

| | Force day 1 | Force day 4 | Force day 10 |
|---|---|---|---|
| | (g) | (g) | (g) |
| Control | 514 ± 17 | 519 ± 68 | 449 ± 90 |
| Control | 518 ± 18 | 568 ± 128 | 593 ± 93 |
| guar | | | |
| Comb. 1 | 473 ± 40 | 519 ± 12 | 552 ± 77 |
| Comb. 2 | 520 ± 73 | 574 ± 31 | 568 ± 52 |
| Comb. 3 | 581 ± 26 | 529 ± 151 | 487 ± 83 |
| Comb. 4 | 568 ± 127 | 607 ± 64 | 567 ± 158 |
| Comb. 5 | 522 ± 84 | 511 ± 35 | 499 ± 75 |
| Comb. 6 | 589 ± 108 | 578 ± 62 | 446 ± 45 |
| Comb. 7 | 545 ± 138 | 541 ± 141 | 467 ± 37 |
| | | | measured in a |
| | | | puffings |
| | | | 686 (If no puffing) |
| Comb. 8 | 572 ± 12 | 569 ± 59 | 610 ± 45 |
| Comb. 9 | 459 ± 64 | 555 ± 102 | 505 ± 111 |
| Comb. 10 | 473 ± 102 | 558 ± 118 | 571 ± 85 |
| Comb. 11 | 453 ± 68 | 498 ± 32 | 543 ± 117 |
| Comb. 12 | 623 ± 62 | 491 ± 104 | 495 ± 86 |

The best combinations were obtained for samples 2 and 10. These results demonstrate the positive effect of using TS-E 251.

The worst combinations were obtained for samples 3 (high level of SMS), 5 (no ascorbic acid), 6 (no SMS), 7 (no TS-E 251) and 12 (no guar 1400).

The results from the combination experiments demonstrate, that it is necessary to develop a product in which all the tested ingredients are included. This product would produce tortillas that in all quality characteristics are better than the present control.

FIG. 3 shows a tortilla made with sample 2. FIG. 3 demonstrates the flexibility of cold tortillas using TS-B products and illustrates, that with the use of combined ingredients a softer and more flexible tortilla can be obtained. The figure shows 1 month old cold tortilla, where the control is rigid and stiff. This tortilla is not able to bend around the stick, and the rollability for the tortilla is poor. The TS-B tortilla is still soft and flexible and has an improved rollability compared to the control.

### Example 3

Different combinations of ingredients—especially different types of hydrocolloids.

TABLE 5
Results from analysis of masa and penetration measurements

| | Stickiness | | Force day 2 | Force day 6 |
|---|---|---|---|---|
| Ingredients | (g) | BU | (g) | (g) |
| 1. Control | 30 ± 2 | 295 (25° C.) | 506 | 533 ± 5.6 |
| 2. CMC B 0.5% | 49 ± 2 | 283 (35° C.) | 499 | 529 ± 42 |
| 3. Guar1400 0.3% | 41 ± 2 | 289 | 466 | 477 ± 79 |
| 4. Carrageenan 0.1% + 0.5% guar + 125 ppm | 42 ± 2 | 275 | 517 | 532 ± 2.1 |
| TS-E 251 | | | | |
| 5. As 4 + 100 ppm ascorbic acid | 41 ± 3 | 275 | 561 | 522 ± 76 |
| 6. As 4 + 100 ppm SMS | 38 ± 5 | 282 | 506 | 497 ± 44 |
| 7. Pectin 0.1% + 0.5% guar + 125 ppm TS-E | 40 ± 3 | 282 | 503 | 524 ± 74 |
| 251 | | | | |
| 8. As 7 + 100 ppm ascorbic acid. | 41 ± 3 | 284 | 564 | 534 ± 61 |
| 9. As 7 + 100 ppm ascorbic acid + 50 ppm | 38 ± 2 | 281 | 523 | 550 ± 37 |
| SMS | | | | |
| 10. As 7 + 100 ppm ascorbic acid + 100 ppm | 40 ± 2 | 288 | 526 | 495 ± 28.7 |
| SMS | | | | |
| 11. 0.3% guar + 125 ppm TS-E 251 | 40 ± 4 | 285 | 533 | 549 ± 44 |
| 12. 0.3% guar + 125 TS-E 251 + 100 asc. + 50 | 45 ± 4 | 283 | 505 | 474 ± 15.5 |
| SMS | | | | |

Reduction of SMS improves resistance (samples 4-6 and samples 8-10). The use of 100 ppm SMS clearly reduces resistance. 50 ppm SMS does not affect resistance negatively.

Using TS-E (125 ppm) in combination with guar shows and improvement in resistance (compare sample 3 and sample 11).

Ascorbic acid (100 ppm) improves resistance measured on day 2. No significant effect is noted on day 6

### Example 4

Different combinations.

TABLE 6
Results from analysis of masa

| | | | | Water | | | |
|---|---|---|---|---|---|---|---|
| | | | | content | | Dough | |
| | | Stickiness | | (tortillas) | Tortilla weight | temp. | Viscosity |
| Ingredients | | (g) | BU | day 2 (%) | (g) | (° C.) | (cP) |
| 1. | Control | 35 ± 1 | 301 | 47.5 | 30 | 34.2 | 4.29 |
| 2. | 0.4% guar | 38 ± 4 | 299 | 49.1 | 30 | 34.1 | 12.7 |
| 3. | 0.35% | 38 ± 2 | 304 | 46.9 | 29.9 | 34.2 | 12.4 |
| | 840 + 0.35% 841* | | | | | | |
| 4. | TS-B 840 0.7% | 41 ± 2 | 307 | 47.1 | 28.3 | 33.4 | 6.79 |
| 5. | TS-B 841 0.7% | 39 ± 2 | 300 | 47.5 | 28 | 33.7 | 17.8 |
| 6. | 0.2% guar + 110 | 44 ± 3 | 296 | 46.3 | 27 | 33.6 | 6.53 |
| | ppm TSE 251 + 90 | | | | | | |
| | ppm Asc + 50 | | | | | | |
| | ppm SMS + 150 | | | | | | |
| | ppm carrageenan | | | | | | |
| 7. | 0.2% guar + 110 | 48 ± 1 | 320 | 47.5 | 25.3 | 34.1 | 6.50 |
| | ppm TSE 251 + 90 | | | | | | |
| | ppm Asc + 50 | | | | | | |
| | ppm SMS + 0.5% | | | | | | |
| | Maseca bulk | | | | | | |
| 8. | 0.6% guar + 110 | 40.9 ± 1.2 | 280 | 47 | 26.3 | 34.2 | 16 |
| | ppm TSE 251 + 90 | | | | | | |
| | ppm Asc. + 50 | | | | | | |
| | ppm SMS + 150 | | | | | | |
| | ppm carrageenan | | | | | | |
| 9. | 0.6% guar + 110 | 45.0 ± 3.0 | 306 | 47.5 | 26.8 | 34.8 | 15.9 |
| | ppm TSE 251 + 90 | | | | | | |
| | ppm Asc + 50 | | | | | | |
| | ppm SMS + 0.1% | | | | | | |
| | corn flour | | | | | | |

*TS-B 840 is composed of guar, TS-E 251, SMS, ascorbic acid, carrageenan and some nixtamal corn flour as filler. TS-B 841 is composed of the same ingredients, but the amount of guar is equivalent to a dosage of 0.6%, while the amount of guar in TS-B 840 is equivalent to a dosage of 0.2% guar.

TABLE 7
Results from penetration measurements

| | Force day 1 | Force day 4 |
|---|---|---|
| Ingredients | (g) | (g) |
| 1. Control | 540 ± 44 | 469 ± 60 |
| 2. 0.4% guar | 592 ± 42 | 509 ± 102 |
| 3. 0.35% 840* + 0.35% 841* | 472 ± 63 | 508 ± 63 |
| 4. TS-B 840 0.7% | 568 ± 79 | 698 ± 102 |
| 5. TS-B 841 0.7% | 536 ± 102 | 463 ± 51 |
| 6. 0.2% guar + | 569 ± 46 | 429 ± 50 |
| 110 ppm TSE 251 + 90 ppm Asc. + | | |
| 50 ppm SMS + 150 ppm carrageenan | | |
| 7. 0.2% guar + | 523 ± 22 | 494 ± 63 |
| 110 ppm TSE 251 + 90 ppm Asc. + | | |
| 50 ppm SMS + 0.5% Maseca bulk | | |
| 8. 0.6% guar + | 465 ± 51 | 488 ± 47 |
| 110 ppm TSE 251 + 90 ppm Asc + | | |
| 50 ppm SMS + 150 ppm carrageenan | | |
| 9. 0.6% guar + | 564 ± 78 | 620 ± 28 |
| 110 ppm TSE 251 + | | |
| 90 ppm Asc. + | | |
| 50 ppm SMS + | | |
| 0.1% corn flour | | |

TS-B 840 gives higher resistance than TS-B 841.

Tortillas produced using TS-B 840 are more rigid compared to tortillas produced using TS-B 841.

The masa consistency is subjectively much better when adding TS-B 841 than TS-B 840.

### Example 5

Different test products.

TABLE 8
Results from analysis of masa

| | | Stickiness | | Tortilla weight | Dough temp. | Viscosity |
|---|---|---|---|---|---|---|
| Ingredients | | (g) | BU | (g) | (° C.) | (cP) |
| 1. | Control | 37 ± 2 | 312 | 28.5 | 35.2 | 4.1 |
| 2. | TS-B 840 (0.7%) | 39 ± 2 | 251 | 28.1 | 34.2 | 6.53 |
| 3. | TS-B 841 (0.7%) | 38 ± 1 | 285 | 29.4 | 35.2 | 17.3 |
| 4. | TS-B 840 | 40 ± 2 | 297 | 29.4 | 35.2 | 10.5 |
| | (0.35%) + TS-B 841 (0.35%) | | | | | |
| 5. | TS-B 840 (0.7%) | 41 ± 1 | 306 | 29.6 | 35.2 | 6.60 |

TABLE 9
Results from penetration measurements

| | Force day 1 | Force day 3 |
|---|---|---|
| Ingredients | (g) | (g) |
| 1. Control | 577 ± 9 | 562 ± 38 |
| 2. TS-B 840 (0.7%) | 586 ± 204 | 517 ± 61 |
| 3. TS-B 841 (0.7%) | 707 ± 91 | 523 ± 86 |
| 4. TS-B 840 (0.35%) + TS-B 841 | 558 ± 52 | 614 ± 22 |
| (0.35%) | | |
| 5. TS-B 840 (0.7%) | 575 ± 46 | 621 ± 140 |

The addition of TS-B 840 to nixtamal flour produces more resistant tortillas than by using TS-B 841. Increasing the content of TS-B 841 produces masa of good consistency (cohesive and none sticky). The produced tortillas are more flexible.

In general the two TS-B products produce good quality tortillas compared to control. Improvements are observed in the following quality characteristics: Masa consistency, surface smoothness, puffings, flexibility, elasticity and resistance.

Materials and methods:

Commercial Scale

| | | |
|---|---|---|
| Masa nixtamal: | 120 kg | (Water content: approx. 58%) |
| Minsa flour: | 40 kg | (Water content: approx. 10%) |
| Water (25° C.)* | 50 kg | |

*Masa nixtamal with high temperatures results in relatively sticky dough.
Water at 25° C. is added in order to optimise masa consistency and to maintain the masa at the desired temperature range.

Mixing conditions: 1 min dry. 3 min wet. Initially the mixing was conducted for 3 min dry and 3 min. wet. However this induced a delay in the process line. Therefore the time was reduced to 1 min. The dry mixing step was new. It was introduced because there were indications that the mixing of the ingredients was inhomogeneous.

Mixing temperature: approximately 35-42° C.

Resting time: 5 - 30 min at ambient temperature

| | |
|---|---|
| Baking conditions: | 385° C. |
| | 299° C. |
| | 300° C. |

Large variations exist from trial to trial. Depending on nixtamal process (cooking and steeping), the resting time and the milling conditions the temperature; humidity and particle size of the masa nixtamal varies even during the production day. Changes in these parameters have large impact on tortilla quality.

Evaluations:

Masa consistency after mixing is subjectively evaluated.

Masa consistency is evaluated for stickiness, cohesiveness and the tendency to be watery.

The control is always given a medium value (marked with an X in the middle of the scheme). If the masa consistency is better than the control, it is marked with an X above the control in the scheme. If the masa consistency is poor, it is marked with an X below the control in the scheme.

Tortilla characteristics are also subjectively evaluated. The same way of evaluation is made, as for the masa consistency.

The following characteristics are evaluated: puffings, elasticity, flexibility, surface smoothness and resistance/strength.

Penetration measurements:

This is conducted as previous described for the pilot testing.

Rollability test:

5 wooden sticks having diameters from 5 mm to 18.6 mm are provided, around which the tortillas is rolled. The evaluation is conducted after warming the tortilla up at approx. 250° C. for 15 seconds on each side followed by 10 seconds on the first side.

### Example 6

Different combinations of ingredients.

TABLE 10
Tested ingredients

| | | | | Ascorbic | TS-E | | |
|---|---|---|---|---|---|---|---|
| Sample no. | | Glucose | SMS | acid | 251 | Guar gum | CMC |
| 1. | Control | | | | | | 0.5% |
| 2. | | | X | X | X | 0.6% | 0.5% |
| 3. | | | X | X | | 0.6% | 0.5% |
| 4. | | | X | | X | 0.6% | 0.5% |
| 5. | | | | X | X | 0.6% | 0.5% |
| 6. | | | | X | | 0.6% | 0.5% |
| 7. | Control | | | | | | 0.5% |
| 8. | | | X | X | X | 0.2% | 0.5% |
| 9. | | | X | X | X | 0.4% | 0.5% |
| 10. | | X | X | X | X | 0.6% | 0.5% |

Results for Masa consistency:

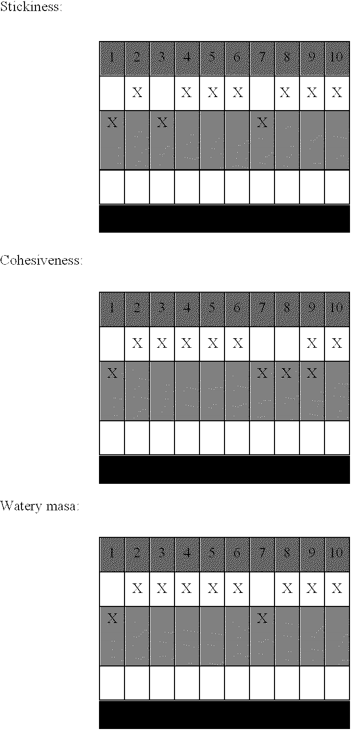

Results for tortilla characteristics:

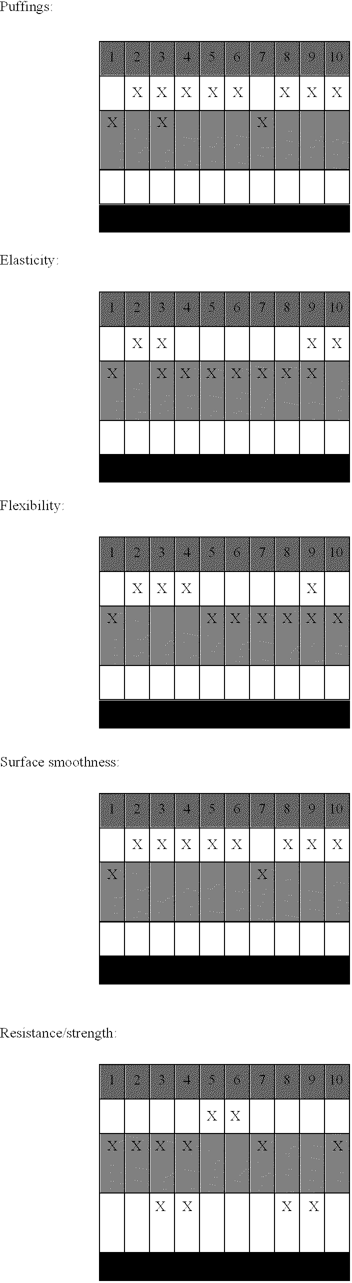

TABLE 11
Results from penetration measurements

| | Force day 1 | Force day 6 | Distance day 6 |
|---|---|---|---|
| Sample No. | (g) | (g) | (mm) |
| 1 Control | 311 ± 49 | 282.5 ± 38.6 | 12.9 ± 1.9 |
| 2 | 380 ± 64 | 319.9 ± 47.7 | 13.7 ± 0.33 |
| 3 | 328 ± 21 | 317.2 ± 59.4 | 13.8 ± 0.79 |
| 4 | 302 ± 18 | 312.3 ± 10 | 14.4 ± 0.22 |
| 5 | 342 ± 25 | 290 ± 41 | 14.5 ± 1.2 |
| 6 | 326 ± 26 | 308 ± 12.0 | 14.8 ± 1.2 |
| 7 Control | 328 ± 34 | 297 ± 66.4 | 13.6 ± 1.5 |
| 8 | 336 ± 22 | 305 ± 59.4 | 13.4 ± 0.4 |
| 9 | 346 ± 22 | N.d | N.d |
| 10 | 374 ± 46 | 283 ± 5.0 | 13.4 ± 0.58 |

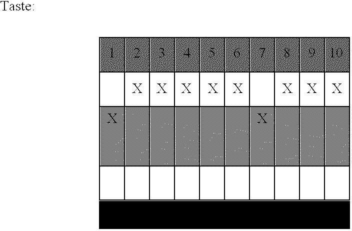

The masa consistency (stickiness and cohesiveness) was improved using the different ingredients. This effect was mainly caused by the use of guar gum. The same effect was seen from the pilot trials. In general the taste of the tortillas produced by the use of combination of ingredients gave a more simple/neutral taste.

SMS produces a softer masa and more flexible tortillas, however the dosage used also produced less resistant tortillas. Therefore the dosage of SMS must be regulated to maintain the positive effects on the masa and the flexibility of tortillas, but prevent the reduction in resistance.

Ascorbic acid and amylase both had a positive effect on elasticity and to some extent on resistance. The effects obtained using these ingredients are parallel to those obtained in the pilot trials.

Aside from obtaining the above positive effects it was also general for the tortillas produced using the combined ingredients that the surface was smoother/softer and that the amount of large puffings increased. Parallel to the effect observed in pilot testing.

The level of glucose and SMS must be regulated in order to obtain the positive effects such as flexibility and taste, without affecting the resistance of the warm tortilla in a negative direction.

### Example 7

Masa nixtamal milling conditions: Milling OK temperature 64° C.

Mixing conditions samples 1-16 (time): 1 min dry. 3 min wet. Resting time: 5 - 30 min at ambient temperature

| | |
|---|---|
| Baking conditions for samples 1 and 2: | 290° C. |
| | 303° C. |
| | 300° C. |
| Baking conditions from sample 3: | 290° C. |
| | 303° C. |
| | 280° C. |

TABLE 12
Tested ingredients

| | | | | | | Water |
|---|---|---|---|---|---|---|
| | | | | | | addition |
| Sample nr. | | TS-B 833* | Glucose | Carrageenan | CMC | (kg) |
| 1. | Control | | | | 0.5% | 52 |
| 2. | | 0.4% | | | 0.5% | 52 |
| 3. | | 0.5% | | | 0.5% | 52 |
| 4. | | 0.6% | | | 0.5% | 52 |
| 5. | | 0.7% | | | 0.5% | 53 |
| 6. | Control | | | | 0.5% | 52 |
| 7. | | 0.6% | | | 0.5% | 53 |
| 8. | | 0.6% | X | | 0.5% | 53 |
| 9. | | 0.6% | ½X | | 0.5% | 53 |
| 10. | | 0.6% | ½X | | 0 | 52 |
| 11. | Control | | | | 0.5% | 52 |
| 12. | | 0.6% | | ½X | 0.5% | 53 |
| 13. | | 0.6% | | X | 0.5% | 53 |
| 14. | | 0.6% | ½X | ½X | 0.5% | 54 |
| 15. | Control | | | X | 0.5% | 52 |
| 16. | | 0.6% | | | 0.25% | 52 |

*TS-B 833 is composed of guar, TS-E 251, ascorbic acid and SMS.

Results for masa consistency:

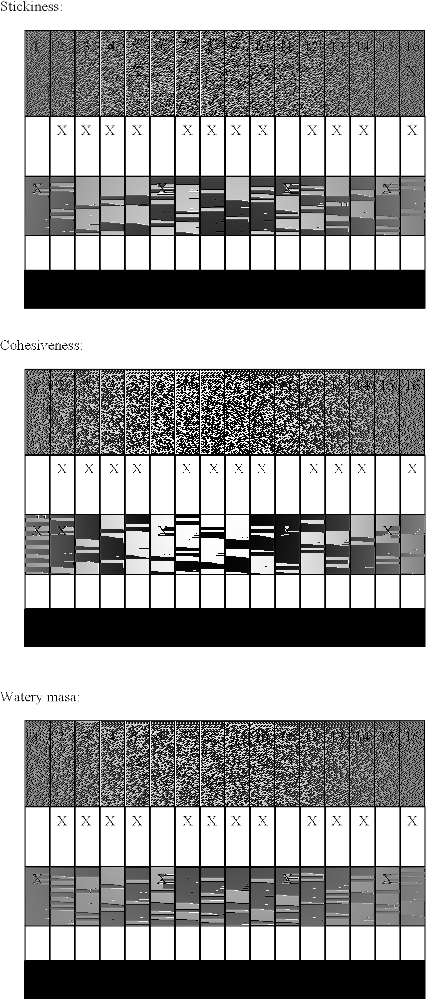

Results for Tortilla characteristics:

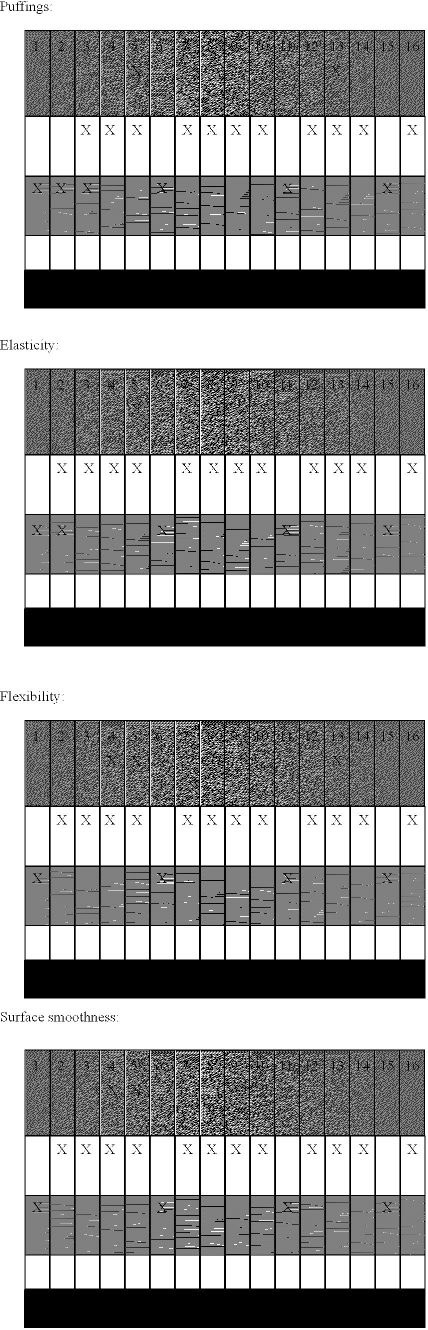

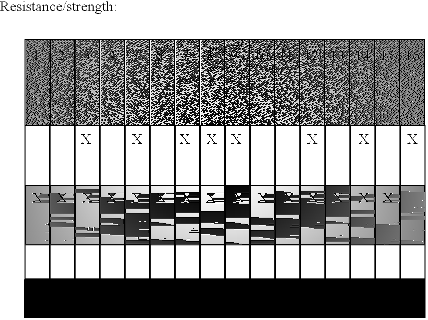

TABLE 13
Results from penetration measurements

| | | | | Distance | | |
|---|---|---|---|---|---|---|
| | Force day 1 | Distance day 1 | Force day | day 3 | | Distance day 7 |
| Sample No. | (g) | (mm) | 3(g) | (mm) | Force day 7(g) | (mm) |
| 1 | 286 ± 28 | 12.8 ± 0.3 | 319 ± 53 | 12.9 | N.d | N.d |
| 2 | 365 ± 35 | 14.4 ± 0.4 | 329 ± 24 | 13.6 ± 0.9 | N.d | N.d |
| 3 | 341 ± 35 | 14.6 ± 1.1 | 354 ± 62 | 15.1 ± 1.3 | 378 ± 46 | 14.8 ± 0.4 |
| 4 | 313 ± 19 | 14.4 ± 0.5 | 332 ± 50 | 14 ± 0.8 | N.d | N.d |
| 5 | 354 ± 23 | 15.4 ± 0.8 | 335 ± 34 | 14.9 ± 0.8 | 309 ± 40 | 14.3 ± 0.9 |
| 6 | 343 ± 34 | 14.2 ± 0.6 | 320 ± 49 | 14.1 ± 0.9 | N.d | N.d |
| 7 | 301 ± 18 | 13.4 ± 0.6 | 354 ± 23 | 16 ± 0.8 | N.d | N.d |
| 8 | 369 ± 50 | 14.7 ± 1.4 | 315 ± 34 | 14.1 ± 1.1 | 336 ± 6.5 | 16.6 ± 0.6 |
| 9 | 353 ± 30 | 15.2 ± 1.4 | N.d | N.d | 305 ± 80 | 14.8 ± 0.5 |
| 10 | 317 ± 37 | 13.2 ± 0.8 | 357 ± 80 | 14.5 ± 1.5 | 354 ± 35 | 15.7 ± 1.0 |
| 11 | 322 ± 26 | 13.6 ± 0.2 | 295 ± 18 | 12.8 ± 0.1 | N.d | N.d |
| 12 | 300 ± 21 | 13.8 ± 1.3 | 326 ± 43 | 14.7 ± 0.2 | N.d | N.d |
| 13 | 317 ± 17 | 15.7 ± 0.7 | 328 ± 30 | 14.6 ± 0.7 | N.d | N.d |
| 14 | 329 ± 24 | 15.4 ± 0.5 | 360 ± 50 | 15.8 ± 0.9 | 323 ± 40 | 14.7 ± 0.1 |
| 15 | 324 ± 20 | 14 ± 0.9 | 309 ± 37 | 13.4 ± 0.5 | 309 ± 19.8 | 14 ± 1.0 |
| 16 | 334 ± 31 | 14.6 ± 0.2 | 381 ± 73 | 14.3 ± 0.9 | 371 ± 23 | 15.4 ± 1.3 |

TABLE 14
Rollability test of selected tortilla samples performed on day 5

| | Evaluation stick | |
|---|---|---|
| Sample No. | no. | Comments |
| 10 | 3 | Rigid and fragile |
| 14 | 5 | Soft, very flexible and resistant |
| 15 | 5 | Rigid, flexible and resistant |
| 16 | 5 | More flexible than control but not as |
| | | resistant as 14. |

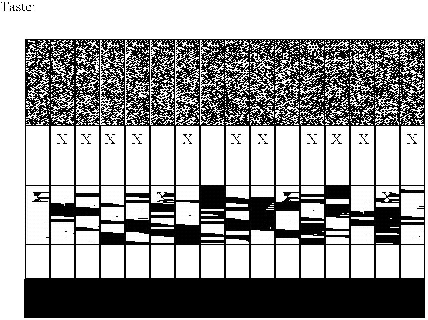

The masa consistency (stickiness and cohesiveness) was improved using TS-B 833 above 0.5% based on dry matter. Removal or reduction of CMC improved masa consistency, but water absorption of masa was reduced.

The surface was smoother/softer and the amount of large puffings increased as the level of TS-B 833 increased.

Resistance was high when using TS-B 833 in levels of 0.4% and 0.5%. However the tortillas were stiffer (less flexible) and the surface was rougher.

There is a tendency that TS-B 833 used in 0.6% has a negative effect on resistance of warm tortilla. This effect might be caused by the use of a relatively high level of SMS (an effect which was also observed in example 6).

Addition of glucose improved taste without affecting other characteristics negatively.

Rollability test performed on selected tortillas showed that tortillas produced using TS-B 833 in combination with CMC produced the best quality tortillas.

The overall best combinations were those were the level of TS-B 833 was 0.7% based on dry matter. Furthermore addition of glucose improved taste without affecting the other quality characteristics in a negative direction.

The best quality tortillas are produced using the developed products in combination with CMC. It is possible to decrease the CMC level depending on desired quality characteristics.

### Example 8

Adjustments of different combinations.

| | |
|---|---|
| Baking conditions for samples 1 to 6: | 284° C. |
| | 305° C. |
| | 275° C. |
| Baking conditions from sample 7: | 290° C. |
| | 305° C. |
| | 275° C. |

TABLE 15
Tested ingredients

| Sample | | TS-B | TS-B | | | Ascorbic | | | Water addition |
|---|---|---|---|---|---|---|---|---|---|
| no. | | 833 | 835* | Glucose | SMS | acid | Carrageenan | CMC | (kg) |
| 1. | Control | | | | | | | 0.5% | 52 |
| 2. | Control | | | | | | | 0.5% | 50 |
| 3. | | 0.5% | | ½X | | | | 0.5% | 50 |
| 4. | | 0.5% | | ½X | | | | 0.5% | 50 |
| 5. | | 0.5% | | ½X | | | | 0.5% | 51 |
| 6. | | 0.5% | | ½X | | | X | 0.5% | 51 |
| 7. | | 0.5% | | ½X | | | X | 0.5% | 51 |
| 8. | | 0.5% | | ½X | | | X | 0.25% | 51 |
| 9. | Control | | | | | | | 0.5% | 50 |
| 10. | | | 0.5% | ½X | 0.8X | 0.8X | | 0.5% | 51 |
| 11. | | | 0.5% | ½X | 0.8X | 0.8X | | 0.5% | 51 |
| 12. | | | 0.5% | ½X | 0.8X | 0.8X | | 0.5% | 52 |
| 13. | | | 0.5% | ½X | 0.8X | 0.8X | | 0.5% | 52 |
| 14. | | | 0.6% | ½X | X | X | | 0.5% | 52 |
| 15. | | | 0.6% | ½X | X | X | | 0.5% | 53 |
| 16. | | | 0.6% | ½X | X | X | | 0.5% | 53 |
| 17. | | | 0.6% | ½X | X | X | | 0.5% | 53 |
| 18. | | | 0.6% | ½X | X | X | | 0.25% | 53 |
| 19. | | | 0.6% | ½X | X | X | | 0.25% | 53 |
| 20. | | | 0.6% | ½X | X | X | | 0.25% | 52 |
| 21. | Control | | | | | | | 0.5% | 50 |
| 22. | Control | | | | | | | 0.5% | 50 |

*TS-B 835 is composed of guar and TS-E 251.

Results for masa consistency:

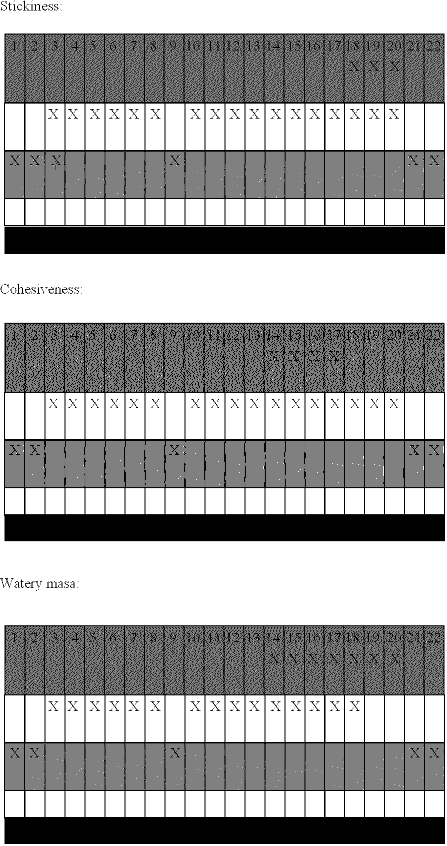

Results for tortilla characteristics:

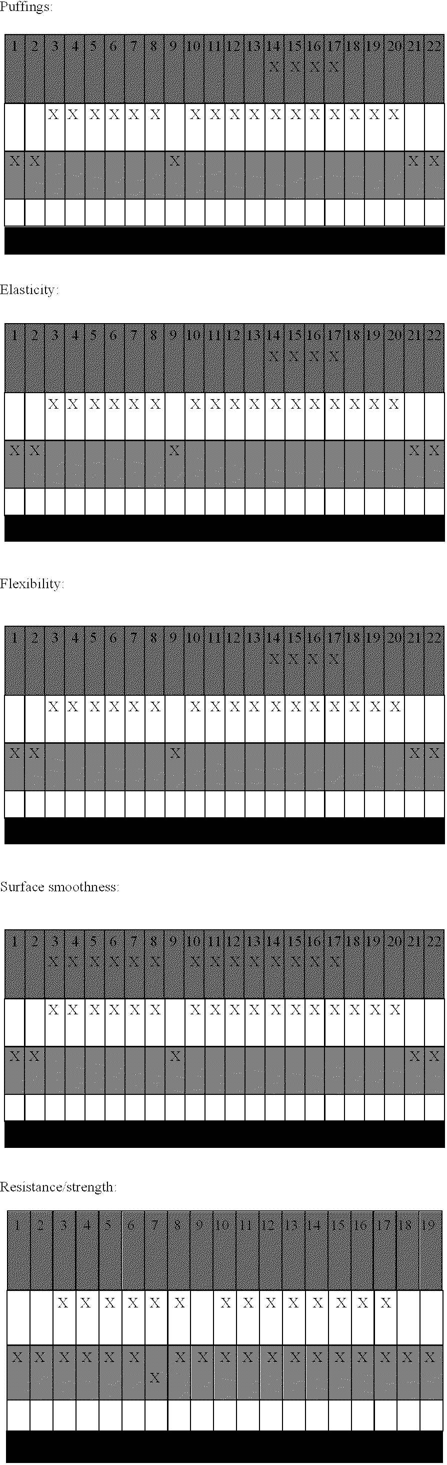

TABLE 16
Results from penetration measurements

| Sample | Force day 1 | Distance day 1 | Force day 4 | Distance day 4 |
|---|---|---|---|---|
| No. | (g) | (mm) | (g) | (mm) |
| 1-2 | 341 ± 37 | 12.8 ± 0.8 | | |
| Control | | | | |
| 3-5 | 363 ± 24 | 14.6 ± 1.7 | 382 ± 41 | 14.8 ± 0.9 |
| 6-8 | 363 ± 27 | 15.0 ± 1 | 356 ± 46 | 15.5 ± 1.3 |
| 9 | 333 ± 18 | 12.4 ± 0.2 | 312 ± 21 | 13.5 ± 0.5 |
| Control | | | | |
| 10-13 | 332 ± 29 | 14.7 ± 0.8 | 329 ± 24 | 14.4 ± 1.3 |
| 14-17 | 344 ± 29 | 14.7 ± 0.7 | 337 ± 33 | 15.4 ± 0.5 |
| 18-20 | 333 ± 18 | 15 ± 1.5 | 352 ± 23 | 15.3 ± 0.4 |
| 21-22 | 321 ± 18 | 12.6 ± 3.5 | 312 ± 50 | 13.4 ± 0.5 |
| Control | | | | |

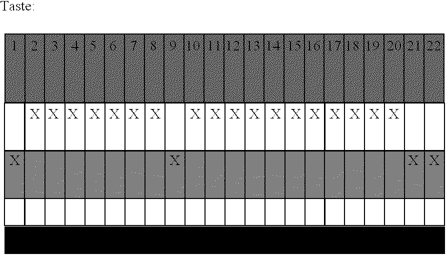 TABLE 17
Results from tortilla liquor analysis

| | Viscosity | |
|---|---|---|
| Sample no. | (cP) | pH |
| 10 | 7.77 | 5.4 |
| 13 | 9.92 | 5.4 |
| 14 | 12.9 | 5.4 |
| 15 | 13.6 | 5.4 |
| 17 | 15.0 | 5.4 |
| 19 | 11.6 | 5.4 |
| 20 | 13.1 | 5.4 |
| 22 | 3.08 | 5.4 |

All tortillas produced using combined ingredients gave improvements in all the tested quality characteristics compared to standard tortilla (control).

The highest resistance were obtained using TS-B 833 in levels of 0.5% in combination with glucose. The cold tortillas were however slightly less resistant than the control.

The best combination was observed in trials 14-17, where the proportion of SMS is reduced and guar is used in levels of 0.6% and glucose is added.

The overall best results very obtained with guar at a level of 0.6%.

Materials and methods:

Commercial Scale 2

Tortilla Type—soft corn tortillas:

| | | | |
|---|---|---|---|
| Masa nixtamal: | 100 | kg | (Water content: approx. 58%) |
| Corn flour: | 60 | kg | (Water content: approx. 10%) |
| Water (25° C.)*: | 68-75 | kg | |

*Masa nixtamal with high temperatures results in relatively sticky dough. Water at 25° C. is added in order to optimise masa consistency and to maintain the masa at the desired temperature range.

Mixing conditions: 1 min. dry mixing of the following ingredients: salt, TS-B 859, CMC and corn flour. This dry mixing step was introduced in order to secure a good distribution of the ingredients. 2.20 min. wet mixing, where water and masa nixtamal were added.

TS-B 859 is a combination of guar gum, glucose, carrageenan, TS-E 251 (amylase), ascorbic acid and SMS.

Mixing temperature: approximately 35-42° C.

Resting time: 5-30 min. at ambient temperature.

Tortilla Type—100% corn flour tortillas:

| | | | |
|---|---|---|---|
| Corn flour: | 100 | kg | (Water content: approx. 10%) |
| Water (25° C.)*: | 117-126 | kg | |

Process Conditions

With the use of the TS-B product some of the process conditions were changed in order to obtain optimal effects. It is important to make the following changes:

Dry mixing step: When the normal soft corn tortillas are produced best results are obtained when this step is included. The mixing is made with TS-B 859, CMC, salt and corn flour. This is done in order to secure a good distribution of the ingredients.

Extra addition of water: The TS-B product generally requires 1-3 kg more water compared to the control. If water is not added, the dough becomes more difficult to process, as it is too hard/stiff. It will therefore fall out of the “rollers”, and the produced tortillas will have a tendency to be folded. The baked tortillas will be more rigid, and the good improvement of the flexibility with the use of TS-B 859 will be reduced.

Regulation of oven temperature: With the use of the TS-B product the top and mid temperature in the oven can be increased a bit compared to the control. This can be done without giving problems with a stiff tortilla, as would be the case for the control. The tortillas can therefore be better baked.

The most important factor is the bottom temperature in the oven, which is preferably decreased. The use of the TS-B product may typically give more puffings, and in order to avoid too many big puffings the temperature may be reduced. More puffings compared to the control are desired, but too many large puffings will give tortillas, which are more fragile in the puffings, and the water evaporation is also increased in tortillas with many big puffings.

### Example 9

Tortilla type: 100% corn flour tortillas

Total masa size: 100 kg

TS-B 859: 0.8%

Objective: To test TS-B 859 in 100% corn flour tortillas.

TABLE 18

| | | | | | Dough | Oven |
|---|---|---|---|---|---|---|
| Masa | Block | | | Water addition | temperature | temperature (° C.) |
| no. | no. | Flour type | Ingredients | (kg) | (° C.) | Top-mid-low |
| 1 | 1 | Minsa | Control | 120 | 28.0 | 246-280-294 |
| 2 | | | | 120 | 27.0 | |
| 3 | | | | 120 | 27.3 | 256-291-301 |
| 4 | 2 | Minsa | TS-B 859 | 120 | 29.5 | |
| 5 | | | 0.8% | 125 | 34.5 | 251-280-293 |
| 6 | | | | 125 | 39.0 | |
| 7 | 3 | Maseca | TS-B 859 | 125 | 32.3 | |
| 8 | | | 0.8% | 125 | 27.7 | |
| 9 | | | | 125 | 26.4 | |
| 10 | 4 | Maseca | Control | 123 | 26.0 | |
| 11 | | | | 124 | 26.4 | |
| 12 | | | | 124 | 26.2 | |

Using 125 kg water in Minsa flour was the absolutely maximum, as this gave some problems with sticky masa during production, and it could probably not have been produced without the use of TS-B 859. However, when 125 kg was used in Maseca flour there were no problems because of better water absorption capacity of this flour.

TABLE 19
Results from penetration measurements

| | | | | Distance |
|---|---|---|---|---|
| | Force day 2 | Distance day 2 | Force day 5 | day 5 |
| Block no. | (g) | (mm) | (g) | (mm) |
| 1 Control | 383 ± 36 | 13.7 ± 1.5 | 298 ± 38 | 14.6 ± 0.8 |
| 2 TS-B 859 | 397 ± 38 | 16.4 ± 0.7 | 434 ± 68 | 17.1 ± 0.8 |
| 3 TS-B 859 | 385 ± 26 | 16.6 ± 1 | | |
| 4 Control | 427 ± 66 | 17.2 ± 2 | | |

Using the Minsa flour together with TS-B 859 gave improved tortillas especially over time. The results reveal that the difference between control and TS-B 859 is higher on day 5 compared to day 2. The resistance of the tortillas is increased, and especially the extensibility of the tortillas is improved. It was evident that the control tortillas were stiff and dry after heating, while tortillas with TS-B 859 were softer and more flexible.

The results from Maseca flour together with TS-B 859 do not demonstrate any improvement of the resistance, while the extensibility is higher. The tortillas with TS-B 859 had, however, the same characteristics as observed before; they are softer, less rigid with a better flexibility compared to the control. TS-B 859 results in improved tortillas, when 100% corn flour is used as raw material.

### Example 10

Tortilla type: Soft Corn Tortillas

TS-B 859: 0.8%

Objective: To test TS-B 859 in normal soft corn tortillas using Maseca corn flour; this time with less difference in the amount of water added.

TABLE 20

| | | | | | Dough | Oven |
|---|---|---|---|---|---|---|
| Masa | Block | | | Water addition | temperature | temperature (° C.) |
| no. | no. | Flour type | Ingredients | (kg) | (° C.) | Top-mid-low |
| 13 | 5 | Maseca | Control | 69 | 30.6 | 251-284-289 |
| 14 | | | | 69 | 34.8 | |
| 15 | | | | 71 | 35.7 | |
| 16 | 6 | Maseca | TS-B 859 | 69 | 35.1 | |
| 17 | | | 0.8% − Etil | 71 | 35.6 | |
| 18 | | | Maltol | 71 | 35.9 | |

TABLE 21
Results from penetration measurements

| | Force day | | | |
|---|---|---|---|---|
| | 2 | Distance day 2 | Force day 5 | Distance day 5 |
| Block no. | (g) | (mm) | (g) | (mm) |
| 5 Control | 403 ± 28 | 17.3 ± 0.5 | 317 ± 61 | 15.1 ± 1.5 |
| 6 TS-B 859 | 472 ± 76 | 18.5 ± 1 | 320 ± 65 | 15.9 ± 1.5 |

Compared to a previous testing (results not shown), the difference between the addition of water to the control and TS-B 859 is less, and this has an impact on the resistance. If too much water is added, the resistance of the tortillas is reduced. Using TS-B 859 does however requires extra water addition, as the tortillas otherwise will loose the improvement of the extensibility.

The subjective evaluation of the tortillas demonstrated improvement of the tortillas using TS-B 859 especially regarding flexibility. This also reflects the problem of only using the texture analyser for conducting the penetration test for evaluation of the tortillas.

Regarding the taste, it was possible to remove Etil Maltol from the tortillas without having negative effects. The taste is more neutral with the use of TS-B 859 and due to this fact, it is possible to eliminate the use of Etil Maltol, which currently is used as “taste improver” in order to mask the taste of the preservatives.

### Example 11

Tortilla type: Soft Corn Tortilla

TS-B 859: 0.8%

Objective: To repeat the testing of TS-B 859 in 0.8% in soft corn tortillas using Minsa and Maseca corn flour, respectively. It was also the purpose to test again, if Etil Maltol could be removed.

TABLE 22

| | | | | | Dough | Oven |
|---|---|---|---|---|---|---|
| Masa | Block | | | Water addition | temperature | temperature (° C.) |
| no. | no. | Flour type | Ingredients | (kg) | (° C.) | Top-mid-low |
| 1 | 1 | Minsa | Control | | | |
| 2 | | | | 64 | 33.4 | |
| 3 | | | | 66 | 35.6 | 260-280-270 |
| 4 | | | | 68 | 34.7 | |
| 5 | | | | 70 | 38.9 | |
| 6 | 2 | Minsa | TS-B 859 | 70 | 43.0 | 270-290-265 |
| 7 | | | 0.8% | 72 | 41.1 | 270-290-260 |
| 8 | | | | 72 | 39.7 | |
| 9 | | | | 70 | 37.6 | |
| 10 | | | | 70 | 42.4 | |
| 11 | 3 | Maseca | TS-B 859 | 72 | 39.1 | |
| 12 | | | 0.8% | 72 | 36.0 | |
| 13 | | | | 72 | 37.3 | |
| 14 | | | | 73 | 38.3 | |
| 15 | | | | 73 | 37.4 | |
| 16 | 4 | Maseca | TS-B 859 0.8% | 73 | 39.3 | |
| 17 | | | No Etil Maltol | 73 | | |
| 18 | | | | 73 | 36.8 | 275-290-261 |
| 19 | | | | 73 | 36.2 | |
| 20 | 5 | Maseca | Control | 73 | 37.1 | |
| 21 | | | | 73 | 37.0 | |
| 22 | | | | 73 | 36.0 | |
| 23 | | | | 73 | 37.2 | |
| 24 | | | | 73 | 38.4 | |

Quality control of masa nixtamal was undertaken. At a time of 6.40 the temperature of masa nixtamal produced on two different lines was measured as 71° C. and 54° C. respectively. The temperature of the masa nixtamal before mixing with the corn flour was 49-52° C. and considered OK.

TABLE 23
Results from penetration measurements

| Block no. | Force day 1 (g) | Distance day 1 (mm) |
|---|---|---|
| 1 Control | 284 ± 70 | 12.3 ± 2.5 |
| 2 TS-B 859 | 360 ± 28 | 14.8 ± 1.3 |
| 3 TS-B 859 | 393 ± 53 | 16.7 ± 0.5 |
| 4 TS-B 859 | 402 ± 59 | 18.0 ± 0.8 |
| 5 Control | 388 ± 104 | 15.5 ± 3.3 |

Based on the results it is evident that for Minsa flour there is an improvement of both the resistance and the extensibility when TS-B 859 is added. This resembles the results from Example 9 using Minsa for 100% corn flour tortillas (see Table 19, blocks 1 and 2). Generally TS-B 859 seems to give better improvements when flour of lower quality (Minsa) is used.

Based on the results from the penetration measurements it is difficult to observe the improvement with TS-B 859 regarding resistance when Maseca flour is used. The resistance is, however, now at least as good as for the control, as the water level is more similar this time. The results reveal that the extensibility is increased with TS-B 859.

Generally earlier experiments have demonstrated that the difference between control and the TS-B product is more pronounced, when the tortillas are older than 1-3 days.

### Example 12

Tortilla type: 100% corn flour tortillas

Total masa size: 100 kg

TS-B 859: 0.8%

Objective: To repeat the testing of TS-B 859 in 100% corn flour (both Maseca and Minsa).

TABLE 24

| | | | | | Dough | Oven |
|---|---|---|---|---|---|---|
| Masa | Block | | | Water addition | temperature | temperature (° C.) |
| no. | no. | Flour type | Ingredients | (kg) | (° C.) | Top-mid-low |
| 1 | 1 | Maseca | Control | 123 | 44.8 | 230-240-231 |
| 2 | | | | 124 | 46.0 | 235-235-227 |
| 3 | | | | 124 | 46.4 | |
| 4* | 2 | Maseca | TS-B 859 | 124 | 46.3 | |
| 5 | | | 0.8% | 126 | 43.2 | |
| 6 | | | | 126 | 37.8 | |
| 7 | 3 | Minsa | TS-B 859 | 122 | 44.2 | |
| 8 | | | 0.8% | 123 | 43.0 | |
| 9 | | | | 123 | 44.6 | |
| 10 | 4 | Minsa | Control | 117 | 43.9 | |
| 11 | | | | 117 | 44.3 | |
| 12 | | | | 119 | 43.3 | |

*without Etil Maltol (only masa no. 4)

The cohesiveness of the masa when using TS-B 859 was improved and at the same time stickiness was reduced.

TABLE 25
Results from penetration measurements

| | Force day | | | |
|---|---|---|---|---|
| | 3 | Distance day 3 | Force day 5 | Distance day 5 |
| Block no. | (g) | (mm) | (g) | (mm) |
| 1 Control | 267 ± 24 | 16.7 ± 0.6 | 298 ± 38 | 14.6 ± 0.8 |
| 2 TS-B 859 | 389 ± 20 | 17.9 ± 0.4 | 434 ± 68 | 17.1 ± 0.8 |

Only tortillas from blocks 1 and 2 were selected for the evaluation on the texture analyser, as results from Example 9 demonstrated that TS-B 859 improves the quality of Minsa tortillas. The results for Maseca tortillas reveal that both resistance and extensibility are increased. The difference between the control and TS-B 859 is more pronounced on day 5 compared to day 2, which is in accordance with earlier observations.

### Example 13

Tortilla type: 100% nixtamal

Total masa size: 200 kg

TS-B 859: 0.8%

Objective: To test TS-B 859 in 100% nixtamal tortillas.

TABLE 26

| | | | | | Oven |
|---|---|---|---|---|---|
| | | | Water | Dough | temperature |
| Masa | Block | | addition | temperature | (° C.) |
| no. | no. | Ingredients | (kg) | (° C.) | Top-mid-low |
| 1 | 1 | Control | | | 240-246-260 |
| 2 | 2 | TS-B 859 0.8% | | | |
| | | No CMC | | | |
| 3 | 3 | TS-B 859 0.8% | | | |

The masa nixtamal for this testing was of very poor quality. The temperature was 75° C., which is too high, and the masa was very sticky. As soon as TS-B 859 was added, it was evident that the consistency of the masa was improved. It became more cohesive and less sticky. Even though CMC was removed in block 2, the masa consistency was still improved.

It was desired that more water should be added in block 3, as the tortillas had difficulties in slipping from the “rollers”, and the masa was stiff. If more water had been added, the benefit of using TS-B 859 could have been more pronounced as less water resulted in slightly stiff tortillas.

TABLE 27
Results from penetration measurements

| Block no. | Force day 3 (g) | Distance day 3 (mm) |
|---|---|---|
| 1 Control | 318 ± 10 | 14.7 ± 0.4 |
| 2 TS-B 859, No CMC | 307 ± 27 | 12.9 ± 1.0 |
| 3 TS-B 859 | 357 ± 46 | 15.3 ± 1.3 |

It was possible to observe improvements of the tortillas when TS-B 859 was added compared to the control. As for the other types of tortillas, tortillas from block 3 were more soft and flexible. They had also a much smoother and more even surface compared to the control. 100% nixtamal tortillas have a shelf life of only three days. Improving the quality of 100% nixtamal tortillas with TS-B 859 is therefore also possible, especially after optimising the process conditions, which had not been done for this example.

### Example 14

Tortilla type: Soft Corn Tortillas

TS-B 859: 0.8%, 0.75%, 0.7%

Objective: To test TS-B 859 in lower dosages and to observe if it was possible to reduce the level of CMC added from 0.4% to 0.5%.

TABLE 28

| | | | | | Dough | Oven temperature |
|---|---|---|---|---|---|---|
| Masa | Block | | | Water addition | temperature | (° C.) |
| no. | no. | Flour type | Ingredients | (kg) | (° C.) | Top-mid-low |
| 1 | 1 | Minsa | Control | 72 | 31.6 | 251-284-289 |
| 2 | | | | 72 | 36.0 | |
| 3 | | | | 72 | 38.0 | |
| 4 | 2 | Minsa | TS-B 859 | 73 | 35.7 | |
| 5 | | | 0.7% | 73 | 39.3 | |
| 6 | | | | 75 | 38.8 | |
| 7 | 3 | Minsa | TS-B 859 | 78 | 39.0 | |
| 8 | | | 0.75% | 79 | 35.6 | |
| 9 | | | | 76 | 33.8 | |
| 10 | 4 | Minsa | TS-B 859 | 70 | 37.5 | 251-284-279 |
| 11 | | | 0.8% | 38 | 39.1 | |
| 12 | | | | 38 | 40.0 | |
| 0-1 | 0 | Minsa | Control | 68 | 37.7 | 251-284-270 |
| 0-2 | | | | 68 | 39.2 | |
| 0-3 | | | | 68 | 38.8 | |
| 0-4 | | | | 68 | 39.8 | |
| 0-5 | | | | 68 | 40.5 | |
| 13 | 5 | Minsa | TS-B 859 | 68 | 40.6 | |
| 14 | | | 0.8% | 72 | 39.6 | |
| 15 | | | CMC 170 g | 72 | 40.0 | |
| 16 | 6 | Minsa | As block no. 5 | 72 | 36.1 | |
| 17 | | | without Etil | 72 | | |
| | | | Maltol | | | |
| 18 | 7 | | TS-B 859 | 72 | 37.5 | |
| | | | 0.75% | | | |
| | | | CMC 170 g | | | |

Quality control of masa nixtamal was undertaken. Masa nixtamal having a temperature of 75° C. and a humidity of 59% was used in the first 3 blocks whilst for the remaining blocks masa nixtamal having a temperature of 60-66° C. and a humidity of 61% was used.

TABLE 29
Results from penetration measurements

| Block no. | Force day 1 (g) | Distance day 1 (mm) |
|---|---|---|
| 1 Control | 337 | 13.4 |
| 2 TS-B 859 | 291 | 15.2 |
| 3 TS-B 859 | 373 | 16.1 |
| 4 TS-B 859 | 380 | 15.1 |
| 0 Control | 371 | 13.0 |
| 5 TS-B 859 | 357 | 15.4 |
| 6 TS-B 859 | 412 | 15.7 |
| 7 TS-B 859 | 395 | 15.2 |

The results revealed that a dosage of TS-B 859 in 0.7% is too low for obtaining an improving effect as the resistance is reduced compared to the control. This could also be verified from the subjective evaluation as the tortillas were slightly fragile (especially cold). The optimal dosage is 0.8% and at the same time it is possible to reduce the level of CMC from 0.5% to 0.4% without having negative effects. This can be observed when block 4 is compared with blocks 5 and 6. It is also possible to eliminate Etil Maltol from the tortillas without affecting the quality of the tortillas.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

The invention will now be further described by the following numbered paragraphs:

1. A process for the preparation of a modified masa foodstuff, the process comprising the steps of
(i) preparing a masa by nixtamalisation of corn
(ii) contacting an enzyme with
(a) the masa, and/or
(b) the corn prior to nixtamalisation;
such that starch native to the corn is modified.

2. A process according to paragraph 1 wherein the enzyme is amylase.

3. A process according to paragraph 1 or 2, further comprising the steps of
(iii) contacting a reducing agent or an enzyme with
(a) the masa, and/or
(b) the corn prior to nixtamalisation;
such that a protein native to the corn is modified;
(iv) contacting an oxidising agent with the modified protein.

4. A process according to paragraph 3 wherein the reducing agent is selected from L-cystein, metabisulfite, inactivated yeast extract (glutathione), derivatives and mixtures thereof.

5. A process according to paragraph 3 or 4 wherein the reducing agent is sodium metabisulphite.

6. A process according to paragraph 3, 4 or 5 wherein the enzyme of step (iii) is selected from reductase, protease, glucose oxidase, hexoseoxidase, transglutaminase and mixtures thereof.

7. A process according to any one of paragraphs 3 to 6 wherein the enzyme of step (iii) is a protease.

8. A process according to any one of paragraphs 3 to 7 wherein the oxidising agent is ascorbic acid.

9. A process for the preparation of a modified masa foodstuff, the process comprising the steps of
(i) preparing a masa by nixtamalisation of corn
(ii) contacting a reducing agent or an enzyme with
(a) the masa, and/or
(b) the corn prior to nixtamalisation;
such that a protein and/or starch native to the corn is modified;
(iii) contacting an oxidising agent with the modified protein and/or starch.

10. A process according to paragraph 9 wherein the oxidising agent is ascorbic acid.

11. A process according to paragraph 9 or 10 wherein the enzyme is selected from amylase, reductase, protease, glucose oxidase, hexoseoxidase, transglutaminase and mixtures thereof.

12. A process according to paragraph 9, 10 or 11 wherein the enzyme is selected from amylase, protease and mixtures thereof.

13. A process according to any one of paragraphs 9 to 12 wherein the reducing agent is selected from L-cystein, metabisulfite, inactivated yeast extract (glutathione), derivatives and mixtures thereof.

14. A process according to any one of paragraphs 9 to 13 wherein the reducing agent is sodium metabisulfite.

15. A process according to any one of the preceding paragraphs wherein the masa foodstuff is selected from corn tortilla, soft tortilla, corn chips, tortilla chips, taco shells, tamales, derivatives and mixtures thereof.

16. A process according to any one of the preceding paragraphs wherein the masa foodstuff is a tortilla.

17. A process according to any one of the preceding paragraphs wherein the masa foodstuff further comprises carrageenan.

18. A process according to any one of the preceding paragraphs wherein the masa foodstuff further comprises guar.

19. A masa foodstuff obtainable or obtained by a process as defined in any one of the preceding paragraphs.

20. A masa foodstuff comprising a modified starch wherein the unmodified starch is native to corn.

21. A masa foodstuff comprising a modified protein wherein the unmodified protein is native to corn.

22. Use of an amylase to improve the interaction of a starch in a masa foodstuff, wherein the starch is native to the corn.

23. Use of a reducing agent or an enzyme in combination with an oxidising agent to improve the interaction of a protein in a masa foodstuff, wherein the protein is native to the corn.

24. Use according to paragraph 23 wherein the oxidising agent is ascorbic acid.

25. A foodstuff comprising (i) corn; (ii) a modified starch and/or modified protein wherein the unmodified starch and/or unmodified protein is native to the corn; (iii) amylase; (iv) ascorbic acid; and (v) a reducing agent.

26. A foodstuff according to paragraph 25 further comprising a hydrocolloid.

27. A foodstuff according to paragraph 26 wherein the hydrocolloid is carrageenan and/or guar gum.

28. A foodstuff according to paragraph 25, 26 or 27 wherein the reducing agent is sodium metabisulphite.

29. A foodstuff according to any one of paragraphs 25 to 28 further comprising glucose.

30. A foodstuff according to paragraph 25 further comprising (vi) carrageenan, (vii) guar gum and (viii) glucose; wherein the amounts of ingredients (iii) to (viii) with respect to the total mass of ingredients (iii) to (viii) is
(iii) amylase 1.2-1.7%

| | |
|---|---|
| (iv) ascorbic acid | 1-1.5% |
| (v) a reducing agent | 0.2-0.3% |
| (vi) carrageenan | 1-2% |
| (vii) guar gum | 60-90% |
| (viii) glucose | 10-15%. |

31. A process as substantially described herein with reference to any one of the Examples.

32. A masa foodstuff as substantially described herein with reference to any one of the Examples.

33. A use as substantially described herein with reference to any one of the Examples.

34. A foodstuff as substantially described herein with reference to any one of the Examples.
